(19) United States
(12) Patent Application Publication
(10) Pub. No.: US 2007/0220764 A1
(43) Pub. Date: Sep. 27, 2007

(54) Precision electronic combination square

(76) Inventor: Kerry D. Wolken, Phelan, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/725,093

(22) Filed: Mar. 16, 2007

Related U.S. Application Data
(60) Provisional application No. 60/785,475, filed on Mar. 24, 2006.

(51) Int. Cl. B43L 13/00

(52) U.S. Cl. 33/427

(57) ABSTRACT

A precision electronic combination square having two elongated blades engaged to a head at perpendicular angles along two side surfaces. A digital display depicts the position of one or both blades as they translate relative to the head through the employment of a magnetic positioning system. An electronic switch allows the user to zero the relative position at any point and initiate a new measurement of travel of the blades.

This application claims the benefit of U.S. Provisional Patent application No. 60/785,475 filed Mar. 24, 2006. The present invention relates to an improvement in the field of combination squares used by carpenters and machinists, artisans, handymen and the like. The combination square is one of the oldest and most commonly used hand tools used by a wide variety of tradesmen. The basic tool is used to achieve a precise 90-degree angle, a precise 45-degree angle, and a sliding blade with a measurement scale that is in most cases twelve inches long. A bubble-leveling vial is adjacent to one of the flat sides.

### FIELD OF THE INVENTION

### Background of the Invention

The combination square as known today was first disclosed by Laroy Sunderland Starrett in U.S. Pat. No. 282,583 in 1883. The Starrett combination square has a bubble vial set in the body for leveling or plumbing surfaces. The body is locked in place by means of a thumbscrew. Although there have been many patents issued to revised concepts of the combination square, most tradesmen use a combination square very similar to the initial one patented by Laroy Southerland Starrett.

Squares used by craftsmen come in a number of varieties including L-shaped framing squares, triangular speed squares, and combination squares, among others. Each square, while performing the same basic function, generally has some advantage over others for particular applications.

For example, a framing square, which generally consists of a long blade and a short blade is useful for marking wide boards, checking the square sides of sheet stock, and laying out framing elements such as rafter or stringers with a scale imprinted on the blades for measurements and angular calculations. A speed square is in the shape of a right triangle and has a flange along its base which can be butted against the workpiece edge allowing the user to rapidly draw a square or 45 degree line. A combination square which includes a shorter handle-like leg, often referred to as a head, that slidably receives a blade, is useful in laying out fine detail work and transferring distances and is often used by machinists and tool and die makers. The head has fences at 90 and 45 degrees that allow the user to quickly transfer a distance accurately and hold it while a line is drawn with a scribe or pencil. Often, the head is provided with a leveling bubble.

The device herein described and disclosed features an improved electronic combination square comprising an elongated blade constructed preferably of a non-magnetic material. An elongated conductor strip constructed of a magnetic material is attached longitudinally into a recessed top surface of the blade. A head has two ninety-degree angle sides and two forty-five degree angle sides constructed of a non-magnetic material. The head will slide to any position along the blades over the conductor strip from either of the two ninety degree angle sides. A fixing means is provided for locking the head to the blade from either of the two ninety degree angle sides. A component in the head provides a means for actuating a signal magnetically relative to the position of the head on the conductor strip in the blade. An assembly in the head is also provided as a means for outputting a visual representation of a dimension measured by the head in accordance with the signal received from the signal-actuating component. Of course other means to track and visually represent the travel of the blades relative to the head can be used and are anticipated; however, the current preferred mode of operation uses magneticly activated components since such a reading device is not subject to damage from dirt, grime, and dust, normally associated with cutting and forming components during measurements.

### REFERENCES SITED

More recently, U.S. Pat. No. 6,785,976 of Michael Morehouse presented a combination square comprising a blade and a head defining a slot in which said blade is at least partially received, said blade extending generally perpendicular to said head, wherein said head is divided into a first portion and a second portion, said first portion defining said slot, wherein said first and second portions are pivotally joined in each other by a pivot assembly, said pivot assembly defining an axis that extends parallel to said blade, whereby said second portion may be rotated about said axis.

This patent describes a conventional combination square where the blade is adjusted by the means of loosening a thumb locking screw and moving the blade by holding the head in one hand and the blade in the other. It is difficult to get the blade in a precise location in this manner. In addition, the measurements must be read from the scale on the blade with reference to one of the flat sides of the head. This combination square has no electronic means to present precise digital measurements, and it cannot be zeroed out at any point along the travel path of the blade to give intermittent measurements within the center of the blade surface.

U.S. Pat. No. 6,553,677 of Manny Szumer describes a combination square including a body with two opposing members, each having a plurality of straight-edged surfaces, and a clamping element adapted to clamp the opposing members together, the opposing members defining a recess therebetween for receiving therein a rule member.

This patent describes a very unconventional combination square with unique capabilities, but it also requires loosening by the means of a nut and moving the blades by hand, and has no means to present visually readable precise measurements.

U.S. Pat. No. 5,446,969 of Robert Terenzoni teaches of a combination square and multi-purpose hand tool that can be utilized as a large number of hand tools including a square, bevel square, stud and ceiling strapping spacer, clamp, caliper, string tender, and scribe. A first L shaped member includes a blade portion and a handle portion. A second member is pivotally and slidably coupled to the blade portion of the first member. Individual member dimensions such as the overall length of the first member, the maximum extended length of the second member along the first member, and the width of the blade portion of the first member are pre-established at selected lengths and widths to provide pre-determined fabrications for the present multi-purpose hand tool such as a stud spacer, ceiling strapping spacer, and string tender.

This patent teaches of a hand tool with a wide variety of unique features that can be utilized by craftsmen, but does not offer the precise electronic measurement and capabilities and reporting of the Precision Electronic Combination Square described within this patent.

While the prior patents and prior art of commercially available combination squares have been successful to a certain extent, it is nonetheless clear that substantial room exists for affecting an advance in the art, which overcomes these shortcomings in a practical and efficient manner.

### THE OBJECTS OF THE INVENTION

It is a general object of this invention to make a precision instrument out of the conventional combination square.

A further object of the invention is to create a combination square with an electronic digital readout.

Another object of this invention is to create a combination square which unlike prior devices can be zeroed out at any point along travel of the blade surface.

Another object of the invention is to create a combination square with a secondary blade engageable at ninety degrees to the primary blade.

Yet another object of this invention is to create a combination square with one or more fine adjustment thumbwheels.

A further object of this invention is to create an alternate embodiment with two separate electronic digital readouts.

Still another object of the invention is to create an alternate embodiment that can be zeroed out in two separate X and Y axes.

A final object of this invention is to make the conventional combination square a state of the art precision hand tool that can be used by a wide variety of craftsmen.

In this respect, before explaining at least one embodiment of the invention in detail, it is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be utilized as a basis for designing of other structures, methods and systems for carrying out the several purposes of the present invention. It is important, therefore, that the claims be regarded as including such equivalent construction insofar as they do not depart from the spirit and scope of the present invention.

### SUMMARY OF THE INVENTION

The preferred embodiment of the precision combination square consists of an improved precision electronic combination square comprising an elongated primary blade constructed of a non-magnetic material with an elongated conductor strip constructed of a magnetic material that is attached longitudinally into a recess on the front surface of the blade. The elongated primary blade slides within a groove in the first working surface with a conventional locking mechanism and a position clamping screw. A secondary elongated blade slides within a groove in the second working surface and is held in position by the means of a similar conventional locking mechanism and a position clamping screw.

The head structure has a first working surface and a second working surface that are at a precise ninety-degree angle to each other. An additional forty-five degree angle working surface is adjacent to the first working surface. In a particularly preferred embodiment, the head structure is constructed of a non-magnetic material and will engage and slide to any position along either the elongated primary blade or the elongated secondary blade. An electronic component in the head provides an electronic means to ascertain a lateral translation measurement, in either direction, of the blade relative to the head for a determination and visual display of such a distance. Currently such means for translation measurement is provided by a means for actuating a signal magnetically relative to the position of the head on the conductor strip in the elongated primary blade and for communicating that position to a means for visual display in the desired degree of distance measurement, of the dimension measured by the head in accordance with the signal received from the signal-actuating component. The system will work in either metric or U.S. customary units. The electronic components may be either a capacitive sensing system or inductive sensing system and still fall within the scope of the particularly preferred mode of this invention. Of course other electronic means for translation measurement of the blade relative to the head can be employed, such as LED or laser reflection from a measurement indicator on the blade, or other electronic means to measure the traverse of the blade relative to the head. However, the current preferred mode uses magnetic operation of a reading device and strip having the acceptable components therein to provide the feedback as to lateral translation in either direction relative to the head.

With either of these electronic systems, the precision combination square herein disclosed has the unique capability of being able to zero out anywhere along the elongated primary blade for precise measurement adjustments. With conventional instruments, mathematical calculations must be done with reference to the end of the blade to establish differences in head positions to obtain the zero position. This cumbersome error-prone problem is eliminated with the disclosed device which is enabled to go to the zero position at any point along the primary blade.

Further, a unique fine adjustment thumbwheel has been incorporated into the design of the precision combination square similar to the ones used on some precision calipers for fine adjustments of the elongated primary blade. On one preferred embodiment of the precision electronic combination square, the elongated secondary blade does not have the electronic components or the fine adjustment thumbwheel and is used to extend the length of the secondary working surface. The elongated secondary blade is held in position by the means of a second position clamping screw.

An alternate preferred embodiment of the precision electronic combination square herein disclosed has a second electronic component engaged adjacent to the secondary working surface along with a second fine adjustment thumbwheel. The elongated secondary blade communicates with a second electronic means to ascertain a lateral translation measurement, in either direction, of the secondary blade relative to the head. In the current preferred mode, this means to ascertain lateral translation will incorporate the conductor strip constructed of a magnetic material attached longitudinally into a recess on the front surface similar to the elongated primary blade with an additional forty-five degree angle working surface that is adjacent to the second working surface. The incorporation of the second electronic component and elongated secondary blade with the magnetic strip will allow craftsmen to work precisely along both the X and Y axes of their work piece, and to zero out either at any point of translation of either the primary or secondary blades.

With respect to the above description then, it is to be realized that the optimum dimensional relationships for the parts of the invention, to include variations in size, materials, shape, form, function and manner of operation, assembly and use, are deemed readily apparent and obvious to one skilled in the art, especially with regard to the electronic means of determining travel of the blade relative to the head since such technologies are constantly evolving. All equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE DRAWINGS

The accompanying drawings, which are incorporated in and form a part of this specification, illustrate embodiments of the invention and together with the description serve to explain the principles of this invention.

FIG. 1 depicts a side view of the precision combination square with a single electronic component for measuring and displaying lateral translation.

FIG. 2 depicts a top view of the precision combination square with a single electronic component.

FIG. 3 depicts a detail view of the fine adjustment thumbwheel mechanism.

FIG. 4 depicts an alternate embodiment of the precision combination square with two electronic components for measuring translation of both a primary and secondary blade.

### DETAILED DESCRIPTION OF THE PREFERRED EMBODIMENTS

For a fuller understanding of the nature and objects of the invention, reference should be had to the following detailed description taken in conjunction with the accompanying drawings which are incorporated in and form a part of this specification, illustrate embodiments of the invention, and together with the description, serve to explain the principles of this invention.

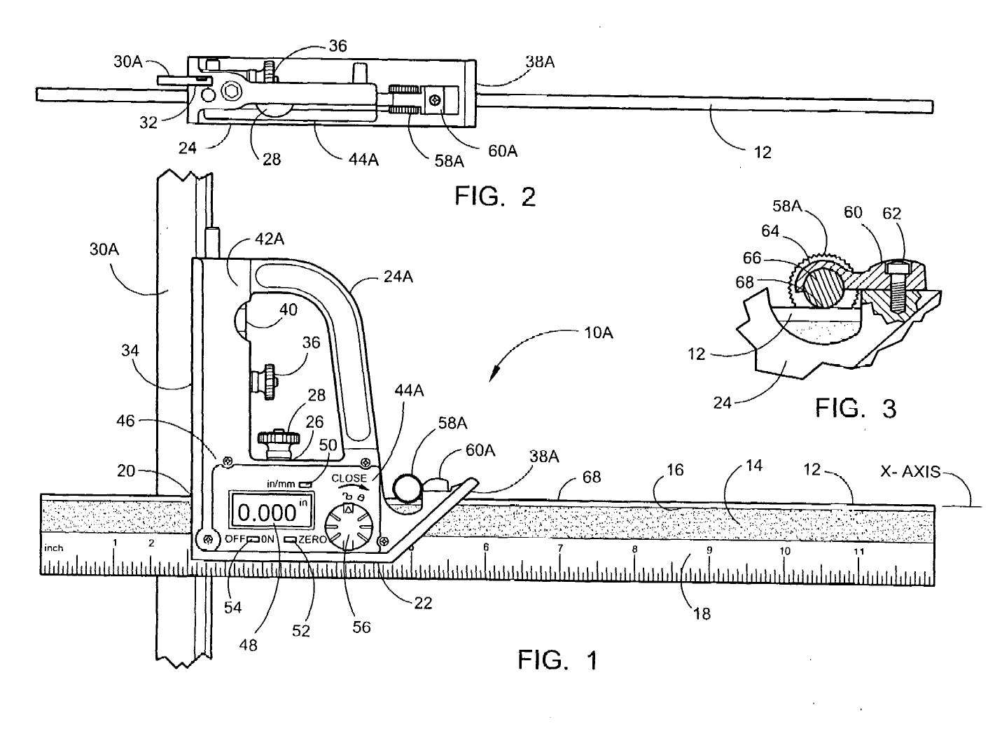

A first preferred embodiment of the precision combination square 10A, shown in FIG. 1 consists of an elongated primary blade 12 constructed of a non-magnetic material such as stainless steel or brass or plastic. Means for electronic determination and communication of translation distance of the blade 12 in the primary blade groove 20 is provided by an elongated conductor strip 14 constructed of a magnetic material conductor strip that is engaged longitudinally into a conductor strip recess 16 on the front surface 18 of the elongated primary blade 12. Such material is conventionally formed in flexible strips of magnetic material that has alternating layers of magnetic material with alternating poles such as the flexible tape of model ZMX40M from Zetex Semiconductor. Other such magnetic material devices, as well as capacitive and inductive and optical systems for distance measurement are well known and commercially available and configurable to measure the translation of the blade 12, in either direction in its engagement relative to the head 24, and this application, of course, anticipates other electronic means to measure translation distance of travel of the blade 12 in either direction relative to the head 24.

The elongated primary blade 12 slides within a primary blade groove 20 in the first working surface 22 of the head structure 24A with a conventional blade locking mechanism 26 and a position clamping screw 28. A secondary elongated blade 30A slides within a secondary blade groove 32 in the second working surface 34 and is held in position by the means of a similar conventional blade locking mechanism 26 and a second position clamping screw 36.

The head structure 24A has a first working surface 22 and a second working surface 34 that are precisely at a ninety-degree angle to each other. An additional forty-five degree angle working surface 38A is adjacent to the first working surface 22. The head structure 24A is constructed of a preferably non-magnetic material such as aluminum, stainless steel, or brass, and may be positioned along either the elongated primary blade 12 or the elongated secondary blade 30A. A bubble leveling vile 40 is adjacent to the second working surface 34 on the upper portion 42A of the head structure 24A and provides a means to determine level positioning of the device.

An electronic component 44A providing means to read the translation of the primary blade 12 is located on the lower front surface 46 of the head structure 24A. The electronic component 44A is for actuating a signal magnetically relative to the position of the head structure 24A with the conductor strip 14 on the elongated primary blade 12, and outputting a signal to produce visual digital representation on the electronic digital reading screen 48 of a dimension of travel measured by the head structure 24A in accordance with the signal received from the signal actuating component. The electronic component 44A will work in either metric or U.S. customary units and may be adjusted by pressing the control button 50. The electronic component 44A, while currently employing magnetic means to determine distance of travel, may be either a capacitive sensing system or inductive sensing system and could also be optical and still fall within the scope of this invention.

As noted earlier, employing such an electronic means to determine translation travel of the blade 12 relative to the head in its slidable engagement, the disclosed combination square 10A has the unique capability of being able to zero out anywhere along the elongated primary blade 12. This unique and useful function is provided by an electronic switch or zero button 52 which will cause the electronic component 44A to reset to a distance of zero and to produce a signal to display a measurement of zero. This reset can be activated at any point of translation of the primary blade 12 relative to the head. Pressing the zero button 52 will thus zero the display, and thereafter translation of the primary blade 12 in either direction will be measured from the zero point. Thus, the zero button allows measurement of distance of translation in either direction of the primary blade 12 relative to the head and thus gives the user great convenience in measuring. The electronic component 44A is turned on and off by pressing the on/off button 54 or could be equipped to automatically turn off after a defined period of time. The battery cover plate 56 is located in the lower right hand corner of the electronic component 44A. A numerical scale of distance is formed on the front surface 18 as a back up translation measurement in case of failure of the electronic component or a dead battery and also as a visual double-check of the electronically calculated relative position.

A unique fine adjustment thumbwheel 58A has been incorporated into the design of the precision combination square 10A. The fine adjustment thumbwheel 58A has been incorporated into the design of the precision combination square 10A for the purpose fine adjustments of the elongated primary blade 12. It is especially important to place the thumbwheel 58A as depicted in FIG. 2, the top view of the precision combination square 10A, where the fine adjustment thumbwheel 58A may be rotated to easily move the elongated primary blade 12 back and forth with the frictionally engaged roller 66 positioned in a recess between the parallel and adjacent roller-engaged thumbwheels 58A.

FIG. 3 depicts a detail view of the fine adjustment thumbwheel 58A with the thumb rest 60A held in place by the means of a screw 62. Thumb rest 60A has an arm 64 that retains centrally located roller 66 in a rotational engagement between the arm 64 and the top surface of the primary blade 12. The arm 64 additionally provides a means to exert pressure on the central area roller 66 against the top surface 68 of the elongated primary blade 12. Especially desirable is the two thumbwheels 58A separated by a recess adapted to engage the arm 64. The two thumbwheels 58A with the gap therebetween, allow for an especially good connection between the surface of the user's thumb and the thumbwheel 58A, as the soft tissue of the thumb will depress into the gap and around both thumbwheels 58A. This allows for much more accurate rolling of the thumbwheel 58A by the thumb and with less pressure thereon than would be required with a single surface thumbwheel. It must be fully understood at this time that a variety of configurations of fine adjustment thumbwheels 58A to accomplish the task of translating the elongated primary blade 12 back and forth are anticipated and will be covered within the scope of this patent. However the depicted configuration is especially well adapted as noted.

Additionally, on the first preferred embodiment of the precision electronic combination square 10A, the elongated secondary blade 30A does not have the magnetic conductive strip 14 and is basically used to extend the length of the second working surface 34 against which the device would engage to then obtain the desired measurement of translation of the primary blade 12 by translation thereof. The elongated secondary blade 30A is held in position by the means of a second position clamping screw 36.

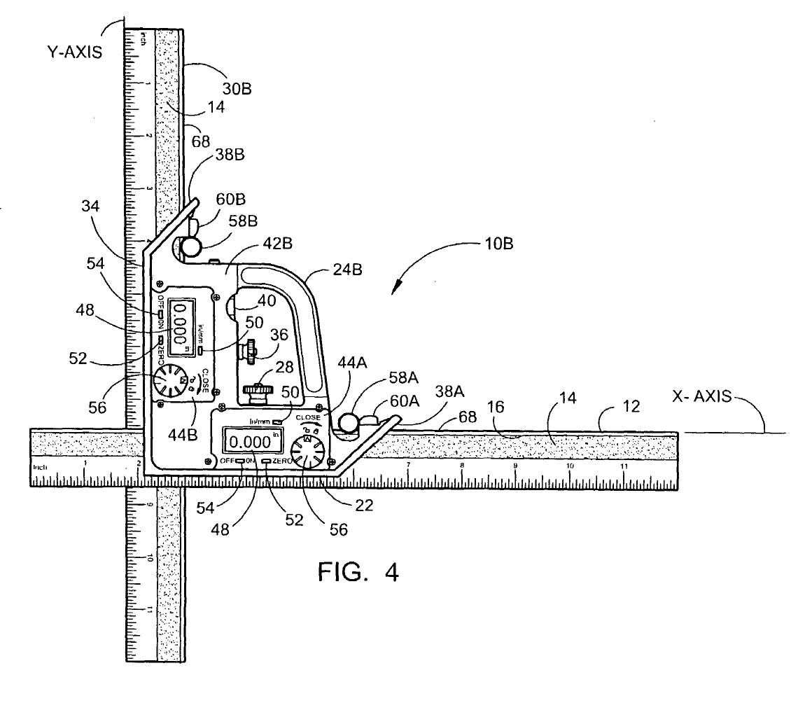

The alternate preferred embodiment of the precision electronic combination square 10B shown in FIG. 4 has a second electronic component unit 44B engaged on the upper portion of the head structure 24B adjacent to the second working surface 34 along with a second fine adjustment thumbwheel 58B and a second thumb rest 60B. The elongated secondary blade 30B will incorporate the conductor strip 14 constructed of a magnetic material attached longitudinally into a conductor strip recess 16 on the blade front surface 18 similar to the elongated primary blade 12. The incorporation of the second electronic component 44B and elongated secondary blade 30B with the conductor strip 14 will allow craftsmen to work precisely along the X and Y axes of their work piece, to measure translation of either blade in either direction, and to zero out either blade at any point in travel, in either direction.

The precision combination square 10A and 10B shown in the drawings and described in detail herein disclose arrangements of elements of particular construction and configuration for illustrating preferred embodiments of structure and method of operation of the present invention. It is to be understood, however, that elements of different construction and configuration and other arrangements thereof, other than those illustrated and described may be employed for providing a precision combination square 10A and 10B in accordance with the spirit of this invention, and such changes, alternations and modifications as would occur to those skilled in the art are considered to be within the scope of this invention as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

What is claimed:

1. An electronic combination square comprising:
an elongated first blade;
a head, said head having two ninety degree angle side surfaces;
said first blade translatably engaged to said head for travel along a first axis parallel to a first of said ninety degree side surfaces;
means for electronic determination of a position, of said first blade relative to said head, at any point of translation of said first blade along said first axis;
electronic means for outputting a visual representation of said position; and
means to change said position of said first blade relative to said head, to zero, at any point of said travel of said first blade along said first axis, wherein the distance of travel of said first blade along said first axis is displayed in a numerical value on said means for outputting, and, said numerical value may be returned to zero and a new distance of travel of said first blade will be displayed as it translates relative to said head thereafter.

2. The electronic combination square of claim 1 wherein said means for electronic determination of a position, of said first blade relative to said head comprises:
a longitudinal recess in a first surface of said first blade;
a magnetic conductor strip engaged longitudinally said recess;
a head-engaged means for reading said conductor strip translating through said head, and actuating a signal relative to the position of said conductor strip relative to said head; and
said means for outputting a visual representation of said position, engaged to an exterior surface of said head and configured to receive said signal and display said visual representation based thereon.

3. The electronic combination square of claim 2 wherein means to change said position of said first blade relative to said head, to zero, is and electronic switch, positioned for an activation by a user, on said head; and
said activation causing said means for reading said conductor strip to reset said position to zero whereafter translation of said first blade will cause a new reading by said means for reading said conductor strip of a new said relative position.

4. The electronic combination square of claim 1 additionally comprising:
a thumb activated controller to translate said first blade, relative to said head;
said controller having a pair of thumbwheels engaged to recessed hub, said hub engaged to said thumbwheels in a gap between said pair of thumbwheels;
a mounting arm engaged at a first end to said head; and
said hub rotationally engaged between a hub mount at a second end of said mounting arm, and a side surface of said first blade, wherein rotation of either or both of said thumbwheels cause a rotation of said hub and a translation of said first blade relative to said head.

5. The electronic combination square of claim 2 additionally comprising:
a thumb activated controller to translate said first blade, relative to said head;
said controller having a pair of thumbwheels engaged to recessed hub, said hub engaged to said thumbwheels in a gap between said pair of thumbwheels;
a mounting arm engaged at a first end to said head; and
said hub rotationally engaged between a hub mount at a second end of said mounting arm, and a side surface of said first blade, wherein rotation of either or both of said thumbwheels cause a rotation of said hub and a translation of said first blade relative to said head.

6. The electronic combination square of claim 3 additionally comprising:
a thumb activated controller to translate said first blade, relative to said head;
said controller having a pair of thumbwheels engaged to recessed hub, said hub engaged to said thumbwheels in a gap between said pair of thumbwheels;
a mounting arm engaged at a first end to said head; and
said hub rotationally engaged between a hub mount at a second end of said mounting arm, and a side surface of said first blade, wherein rotation of either or both of said thumbwheels cause a rotation of said hub and a translation of said first blade relative to said head.

7. The electronic combination square of claim 1 additionally comprising:
an elongated second blade; and
said second blade translatably engaged to said head for travel along a second axis perpendicular to said first of said ninety degree side surfaces.

8. The electronic combination square of claim 2 additionally comprising:
an elongated second blade; and
said second blade translatably engaged to said head for travel along a second axis perpendicular to said first of said ninety degree side surfaces.

9. The electronic combination square of claim 3 additionally comprising:
an elongated second blade; and
said second blade translatably engaged to said head for travel along a second axis perpendicular to said first of said ninety degree side surfaces.

10. The electronic combination square of claim 4 additionally comprising:
an elongated second blade; and
said second blade translatably engaged to said head for travel along a second axis perpendicular to said first of said ninety degree side surfaces.

11. The electronic combination square of claim 8 additionally comprising:
a thumb activated second controller to translate said second blade, relative to said head;
said second controller having a second pair of thumbwheels engaged to second recessed hub, said second hub engaged to said second pair of thumbwheels in a gap between said second pair of thumbwheels;
a second mounting arm engaged at a first end to said head; and
said second hub rotationally engaged between a hub mount at a second end of said second mounting arm, and a side surface of said second blade, wherein rotation of either or both of said second pair of thumbwheels cause a rotation of said second hub and a resulting translation of said second blade relative to said head and perpendicular to the travel of said first blade.

12. The electronic combination square of claim 9 additionally comprising:
a thumb activated second controller to translate said second blade, relative to said head;
said second controller having a second pair of thumbwheels engaged to second recessed hub, said second hub engaged to said second pair of thumbwheels in a gap between said second pair of thumbwheels;
a second mounting arm engaged at a first end to said head; and
said second hub rotationally engaged between a hub mount at a second end of said second mounting arm, and a side surface of said second blade, wherein rotation of either or both of said second pair of thumbwheels cause a rotation of said second hub and a resulting translation of said second blade relative to said head and perpendicular to the travel of said first blade.

13. The electronic combination square of claim 10 additionally comprising:
a thumb activated second controller to translate said second blade, relative to said head;
said second controller having a second pair of thumbwheels engaged to second recessed hub, said second hub engaged to said second pair of thumbwheels in a gap between said second pair of thumbwheels;
a second mounting arm engaged at a first end to said head; and
said second hub rotationally engaged between a hub mount at a second end of said second mounting arm, and a side surface of said second blade, wherein rotation of either or both of said second pair of thumbwheels cause a rotation of said second hub and a resulting translation of said second blade relative to said head and perpendicular to the travel of said first blade.

14. The electronic combination square of claim 8 additionally comprising a means for electronic determination of a position, of said second blade relative to said head comprising:
a second longitudinal recess in a first surface of said second blade;
a second magnetic conductor strip engaged longitudinally said second longitudinal recess;
a second head-engaged means for reading said second conductor strip translating through said head, and actuating a second signal relative to a location of said second conductor strip relative to said head; and
means for outputting a visual representation of said location, engaged to an exterior surface of said head and configured to receive said second signal and display said visual representation based thereon.

15. The electronic combination square of claim 9 additionally comprising a means for electronic determination of a position, of said second blade relative to said head comprising:
a second longitudinal recess in a first surface of said second blade;
a second magnetic conductor strip engaged longitudinally said second longitudinal recess;
a second head-engaged means for reading said second conductor strip translating through said head, and actuating a second signal relative to a location of said second conductor strip relative to said head; and
means for outputting a visual representation of said location, engaged to an exterior surface of said head and configured to receive said second signal and display said visual representation based thereon.

16. The electronic combination square of claim 10 additionally comprising a means for electronic determination of a position, of said second blade relative to said head comprising:
a second longitudinal recess in a first surface of said second blade;
a second magnetic conductor strip engaged longitudinally said second longitudinal recess;
a second head-engaged means for reading said second conductor strip translating through said head, and actuating a second signal relative to a location of said second conductor strip relative to said head; and
means for outputting a visual representation of said location, engaged to an exterior surface of said head and configured to receive said second signal and display said visual representation based thereon.

17. The electronic combination square of claim 11 additionally comprising a means for electronic determination of a position, of said second blade relative to said head comprising:
a second longitudinal recess in a first surface of said second blade;
a second magnetic conductor strip engaged longitudinally said second longitudinal recess;
a second head-engaged means for reading said second conductor strip translating through said head, and actuating a second signal relative to a location of said second conductor strip relative to said head; and
means for outputting a visual representation of said location, engaged to an exterior surface of said head and configured to receive said second signal and display said visual representation based thereon.

18. The electronic combination square of claim 12 additionally comprising a means for electronic determination of a position, of said second blade relative to said head comprising:
a second longitudinal recess in a first surface of said second blade;
a second magnetic conductor strip engaged longitudinally said second longitudinal recess;
a second head-engaged means for reading said second conductor strip translating through said head, and actuating a second signal relative to a location of said second conductor strip relative to said head; and
means for outputting a visual representation of said location, engaged to an exterior surface of said head and configured to receive said second signal and display said visual representation based thereon.

19. The electronic combination square of claim 13 additionally comprising a means for electronic determination of a position, of said second blade relative to said head comprising:
a second longitudinal recess in a first surface of said second blade;
a second magnetic conductor strip engaged longitudinally said second longitudinal recess;
a second head-engaged means for reading said second conductor strip translating through said head, and actuating a second signal relative to a location of said second conductor strip relative to said head; and
means for outputting a visual representation of said location, engaged to an exterior surface of said head and configured to receive said second signal and display said visual representation based thereon.

20. The electronic combination square of claim 19 additionally comprising:
a forty-five degree side on said head.
